(19) United States
(12) Patent Application Publication
(10) Pub. No.: US 2012/0071551 A1
(43) Pub. Date: Mar. 22, 2012

(54) ETHANOLIC EXTRACTS OF HASS AVOCADO SEEDS, Persea americana Mill., AND ITS USE AS MITICIDE FOR Panonychus citri, Oligonychus yothersi, AND Tetranychus cinnabarinus, AND AS AN INSECTICIDE FOR Trialeurodes vaporariorum

(76) Inventor: Robinson Vargas Mesina, Santiago (CL)

(21) Appl. No.: 13/232,449

(22) Filed: Sep. 14, 2011

(30) Foreign Application Priority Data
Sep. 16, 2010 (CL) 201000987

(51) Int. Cl. A01N 43/08; A01P 7/04; A01P 7/02

(52) U.S. Cl. 514/461

(57) ABSTRACT

An ethanolic extract of avocado seeds with a composition of 2-Furfuraldehyde (1,00%), 5-Methylundecane (1,05%), (11Z)-Pentadecenal (0,98%), (11Z)-Hexadecenal (2,35%), (3E)-Nonadecene (1,07%), 2-Tetradecylfuran (5,58%), 2-Pentadecylfuran (7,10%), 2-Hexadecylfuran (6,52%), 2-(1Z-Heptadecenyl) furan (2,85%), 2-(1E-Pentadecenyl) furan (2,15%), 2-(1E-Heptadecenyl) furan (5,60%), 2-(8Z, 11Z-Heptadecadienyl) furan (5,49%), 2-(8Z, 11 E-Heptadecadienyl) furan (33,53%), 2-(1 E, 8Z, 11Z-Heptadecatrienyl) furan (15,56%), and other unidentified compounds (9,17%), useful as miticide and insecticide is described.

### DESCRIPTION

Many pesticides cause severe unfavorable effects including a high toxicity in humans and animals, a relatively high phytotoxicity in plants, and an increasing resistance level in insects and mites. Despite the wide spectrum of pesticides currently available, pests continue to remain a serious problem and environmentally friendly biocides have yet to be developed.

This invention refers to biopesticides composed of an alcoholic extract of avocado seeds with ethanol for the control of the Panonychus citri, Oligonychus yothersi, and Tetranychus cinnabarinus mite species as well as the Trialeurodes vaporariorum insect species. More specifically, we refer to how to obtain and use of the compounds extracted with ethanol from the avocado seeds as well as characterization of the composition and their structure by chromatographic and spectroscopic methods. The extracts were then applied as ethanolic solutions for the control of mature Panonychus citri, Oligonychus yothersi, and Tetranychus cinnabarinus mites as well as the nymph-stage of Trialeurodes vaporariorum insects.

### BACKGROUND ART AND RELATED DISCLOSURES

It is generally known that components from both the leaves and the pulp from avocado seeds have certain toxic effects on animals and on specific stages of insect development (Univ. California Cooperative Extension, San Diego County Farm Advisor Agricultural News (1997)). However, there are two different approaches of study that one can take to ascertain a clear, systematic and reproducible method of identifying the specific components responsible for these toxic effects. The first approach refers to the use of avocadofuran compounds obtained from avocados to hinder the larval stage development of specific insects. Using this approach, unsaturated derivatives of furans such as persin (1-acetoxy-2-hydroxy-4-oxo-heneicosa-(12Z, 15Z)-diene) are known to inhibit the growth in the fourth larval stage of the Bombyx mori L. silkworm (Agr. Biol. Chem., 39: 1167 (1975) and of Spodoptera exigua (Entomol. Experiment. Applic. 90(2), 131-140, 1999).

Regarding the same growth inhibition effects on insect larval development, U.S. Pat. No. 6,133,313 by Thomson and collab. (2000) stated that oily fractions of idioblast cells from the pulp (and not from the avocado seed, as in the present invention) of Persea americana Mill. avocados (Lauraceae) contain avocadofurans which are responsible for the inhibitory effects on insect larvae.

The second approach of development refers to the use of constitutive compounds from avocado seeds by the same authors of the present invention (Chilean Patent Application N° 2007003612, Vargas R., and Buono-Core G.) in which avocadofurans with a composition different from those in the first approach of development (indicated above) were found to be effective as a miticide for Tetranychus urticae and Brevipalpus chilensis in addition to an insecticide for Hemiberlesia lataniae and Heliothrips haemonrrhoidalis.

For the Panonychus citri, Oligonychus yothersi, and Tetranychus cinnabarinus mites as well as for the Trialeurodes vaporariorum insect, the following studies show the current state of knowledge:

### a) Panonychus Citri:

The U.S. Pat. No. 4,640,836 (Boulter, A. and collab.) used a trypsin and chymotrypsin inhibitor extracted from the seeds of plants. The inhibitor solutions of these enzymes are sprayed on cotton plants having different pests, which also include the Panonychus citri red spider. In general, the extracts of Vigna unguiculata (commonly known as cowpea) are preferred.

The results show that once in contact with these enzymatic biocides, both the larvae and the mature species have a lethality of 100% within 5 days.

The U.S. Pat. No. 7,731,984 (Sztejnber, A. and collab.) used an extract of a liquid that comes from the cultivation medium of three new species of mushrooms—Meira geulakonigae (CBS 110052), Meira argovae (CBS 110053) and Acaromyces ingoldii (CBS 110050). These extracts have miticide and/or fungicide activity. The liquid extract in suspension contains around 10⁷−10¹⁰ spores/ml and is active against Panonychus citri. Infected plants are treated with an aspersion of the miticide. The pest control experiments were continued for 15 days and resulted in over 80% lethality in the mites.

The patent JP 08-301715 (Nara M. and Okada F.) used an oil extracted by steam distillation from leaves or branches of laurel as a miticide for Panonychus citri. An aqueous solution containing a surfactant is used for spraying the oil on larvae or on mite imagoes at a concentration of 0.1 to 5.0% and causes death after 2-5 days.

### b) Oligonychus Yothersi

The red spiders Oligonychus yothersi, Oligonychus persea, and Tetranychus urticae are often exposed to conventional miticides (Infoagro Systems), including a mixture of QL Agri 35+Acoidal WG+Break (BASF Chile). For example, registered miticides in Florida include abamectin, permethrin, piriproxifen, and sulfur (Florida Crop/Pest Management Profile: Avocado, Mosler M. A. and Crane, J. H., University of Florida, USA, 2008).

For the purpose of controlling these species with natural biocides which are part of the control tools for organic cultivations, patents covering a technical solution concerning their presence as a pest of the avocado tree have not been described.

### c) Tetranychus Cinnabarinus

Although there are basic research studies on the control of Tetranychus cinnabarinus, there is not yet an efficient organic or biological alternative to control this particular mite species.

The U.S. patent application 20090263511 (Shah, S. A. and Horsler, Ch. W.) described the application of a dill oil (of Anethum sowa) or a mixture of two or more of the extracted constituents of dill seeds as an enhancer of a pyrethroid or other commercially available pesticides. The concentrated dill extract is used as a solution in ethyl lactate at a concentration of 3 to 40% (w/w) of the aspersion solution. The enhanced miticide solution produces a lethality of 100% between days 4 and 14 from its application.

### d) Trialeurodes Vaporariorum

The U.S. patent application 20090030087 (Chiasson, H.) described the use of plant extracts, particularly compositions of the oil constituents from various parts of the Chenopodium sp plant. The biocide compositions of this invention include alpha-terpinene, rho-cimene, limonene, carvacrol, carveol, nerol, timol, and carvone.

When adults of the Trialeurodes vaporariorum species undergo the action of a mixture of biocides, mortality is achieved after 24 hours. Thus, a suitable biocide is able to achieve a certain level of control at the mature insect stage but not at the nymph stage.

The U.S. patent application 20100120724 (Bessette, S. M.) described the use of essential plant oils or individual components of plant oils extracted from different plants, along with commercially synthesized insecticides for Trialeurodes vaporariorum. Examples include DR-F-048, RAID of SC Johnson Co., Raid RTM containing aletrina, MGK 246, and other compounds.

The amount of essential oil compounds used is approximately 0.1% to 50% of the total pesticide composition. When working with larvae, the time to achieve 100% lethality is approximately 30 to 40 minutes.

According to these prior findings, it can be concluded that the effect of biocides on the Panonychus citri, Oligonychus yothersi, and Tetranychus cinnabarinus mites is lethal over a period of several days. Therefore, a biocide with a higher efficiency of lethality and that particularly targets the nymph stage is required, which is the objective of the present invention.

As for the mortality of Trialeurodes vaporariorum produced by bioinsecticides, studies of the state of the art refer to the larval stage. This stage ranges only from 1 to 2 hours of life, a very short time to act and control the insects with the application of biocides that contain a commercial pesticide. However, for control using completely natural or biological biocides, it is desirable for the biocide to produce lethality at the nymph stage because this is a longer developmental stage (approximately 1 month), within which a higher degree of lethality can be achieved. This represents another objective of the present invention, specifically for Trialeurodes vaporariorum, in which a more efficient control is attempted to target insects in the nymph stage.

Regarding the use of the ethanolic extracts as miticides and insecticides in the present invention, the avocado seeds of the Persea americana Mill. variety are extracted with ethanol, which is shown to contain aldehydes (such as 2-furanal and (11Z)-pentadecenal), (11Z)-hexadecenal, hydrocarbonated compounds (such as 5-metilundecane and (3E)-nonadecene), and avocadofurans that are absent from the pulp of the avocado. Such ethanolic extracts are applied to mature Panonychus citri, Oligonychus yothersi, and Tetranychus cinnabarinus mites as well as to the Trialeurodes vaporariorum insect.

### DETAILED DESCRIPTION OF THE INVENTION

Extraction of Biocides from Avocado Seeds: A batch method of extraction was used with ethanol as the solvent at its boiling temperature in a Soxhlet extractor. The Hass avocado seeds were cleaned, put into a domestic mincer (Moulinex), and processed for 2 minutes. The processed seeds were then placed onto a tray previously covered with aluminum foil and distributed to form a layer not more than 3 cm in thickness. The seeds were then dried in a stove (ZHICHENG ZFD-A5090) at 50° C. for 12 hours. Milled seeds (100 g) were weighed, placed inside a 2-L Erlenmeyer flask, and extracted with 1.6 L of ethanol. During the extraction, the seeds were subjected to reflux for 5 continuous hours, and the product was filtered using a Whatman No. 2 filter paper. The solvent was then evaporated from the filtrate in a rotary evaporator (Buchi R-215) to a temperature not exceeding 42° C. to obtain a viscous extract (yield of 8.8%) that was brownish in color.

The extract was analyzed by gas chromatography coupled to mass spectrometry (GC-MS) and then subjected to a subsequent separation by preparative chromatography in a glass column (CC) (30 cm long with an internal diameter of 22 mm), which was packed with Silica Gel 60 (0.040-0.063 mm, Merck) up to a height of 15 cm; a 20-mm layer of SiO₂ (Aldrich) was also added at the superior part. The elution was made with mixtures of ethyl acetate-hexane-acetic acid (from 5:15:1 to 10:10:1).

### Composition of the Ethanolic Extracts of the Biocide

The extracts and fractions of preparative column chromatography were submitted to spectroscopy in an UV spectrophotometer (Shimadzu GCMS-QP5050) under the following conditions: sample volume of 1 μl; injector and detector temperature of 250° C.; initial temperature of 80° C. with a 2-minute ramp; final temperature of 250° C. with a 10-minute ramp; heating speed of 10° C./min; DB-5 column (30 m×25 mm×1 μm; m/z sweep 40-400 UMA). Table 1 shows the constituent compounds of the ethanol extract and their quantities.

TABLE 1
Composition of Ethanolic Extracts of Biocides using Hass Avocado Seeds

| Compound | Quantity (%) |
|---|---|
| 2-Furfuraldehyde | 1.00 |
| 5-Methylundecane | 1.05 |
| (11Z)-Pentadecenal | 0.98 |
| (11Z)-Hexadecenal | 2.35 |
| (3E)-Nonadecene | 1.07 |
| 2-Tetradecylfuran | 5.58 |
| 2-Pentadecylfuran | 7.10 |
| 2-Hexadecylfuran | 6.52 |
| 2-(1Z-Heptadecenyl)furan | 2.85 |
| 2-(1E-Pentadecenyl)furan | 2.15 |
| 2-(1E-Heptadecenyl)furan | 5.60 |
| 2-(8Z,11Z-Heptadecadienyl)furan | 5.49 |
| 2-(8Z,11E-Heptadecadienyl)furan | 33.53 |
| 2-(1E,8Z,11Z-Heptadecatrienyl)furan | 15.56 |
| Not Identified | 9.17 |

As can be observed from Table 1, the extracts used in this invention have a composition different from the known avocadofuran constituents of idioblast cells in the Hass avocado pulp (U.S. Pat. No. 6,133,313). The extracts of this invention are miticides and insecticides, while the known avocadofurans only have inhibitory activity against certain larval stages of insects.

### BIOASSAYS OF ACARICIDE AND INSECTICIDE ACTIVITY OF THE ETHANOLIC EXTRACTS

### a) Oligonychus Yothersi (McGregor).

The lethal effect of avocado seed extracts was evaluated at a concentration of 5000 ppm in 30% (v/v) ethanol in water on mature Oligonychus yothersi (McGregor). These direct application bioassays were carried out on Hass avocado leaf disks (Persea americana) over humidified cotton, on which the mature stages were deposited. Two milliliters of avocado seed extract at 5000 ppm in ethanol at 30% (v/v) was applied by means of aspersion with a Potter Tower (Burkard Manufacturing Co Ltd.). An experimental unit corresponded to 10 adult mites contained on a single leaf piece; 5 repetitions for each treatment were carried out, in addition to a control with ethanol at 30% (v/v) in water and a control with only distilled water. The lethality in adults was evaluated 24 h after application.

### b) Tetranychus Cinnabarinus (Boisduval)

The lethal effect of the avocado seed extract was evaluated at a concentration of 5000 ppm in 30% (v/v) ethanol in water on mature Tetranychus cinnabarinus (Boisduval) by means of bioassays of direct application. These bioassays were carried out on disks of Apollo bean leaves (Phaseolus vulgaris), over humidified cotton, on which the mature stages were deposited. Two milliliters of avocado seed extract at 5000 ppm in 30% (v/v) ethanol in water was applied by means of aspersion with a Potter Tower (Burkard Manufacturing Co Ltd.). An experimental unit corresponded to 10 adult mites contained on a single leaf piece; 5 repetitions for each treatment were carried out, in addition to a control in 30% (v/v) ethanol in water and a control with only distilled water. The lethality in adults was evaluated 24 h after application.

### c) Panonychus Citri (McGregor)

The lethal effect of the avocado seed extract was evaluated at a concentration of 5000 ppm in 30% (v/v) ethanol in water on mature Panonychus citri (McGregor) by means of bioassays of direct application. These bioassays were carried out on disks of orange tree leaves (Citrus sinensis) over humidified cotton, on which the mature stages were deposited. Two milliliters of avocado seed extract at 5000 ppm in 30% (v/v) ethanol in water was applied by means of aspersion with a Potter Tower (Burkard Manufacturing Co. Ltd.). An experimental unit corresponded to 10 adult mites contained on a single leaf piece; 5 repetitions for each treatment were carried out, in addition to a control with 30% (v/v) ethanol in water and a control with distilled water. The lethality in adults was evaluated 24 h after application.

### d) Trialeurodes Vaporariorum (Westwood)

Nymph-stage Trialeurodes vaporariorum (Westwood) were gathered from a plot of land dedicated to the cultivation of commercial tomatoes, and the lethal effect of the avocado seed extract was evaluated at a concentration of 5000 ppm in 30% (v/v) ethanol in water by means of bioassays of direct application. These bioassays were carried out on young Patron tomato leaves (Lycopersicum esculentum) over humidified cotton, on which the nymphs were deposited. Two milliliters of avocado seed extract at 5000 ppm in 30% (v/v) ethanol in water was applied by means of aspersion with a Potter Tower (Burkard Manufacturing Co Ltd.). An experimental unit corresponded to 20 insect nymphs contained on each young leaf; 5 repetitions for each treatment were carried out, in addition to a control with 30% (v/v) ethanol in water and a control with distilled water. The lethality in nymphs was evaluated 4 days after application. The environmental conditions were controlled as described in the following paragraph.

For all of the evaluated pests, a completely randomized experimental design was used. The lethality values of each treatment were subjected to ANDEVA and the separation of averages (x) through Tukey's test using the SAS statistical software. The environmental conditions were a light:dark photoperiod of 16:8 hrs, temperature of 22° C.±2° C., and relative humidity of 75%±10%.

The lethality results in mites and insects are shown in Tables 2 through 5.

### a) Lethality of Panonychus Citri

TABLE 2
Effect of direct application on Panonychus citri adults in the laboratory.
La Cruz, Valparaíso Region, Chile, 2009.

| Treatments | Lethality (%) |
|---|---|
| Avocado seed extract at 5000 ppm in 30% v/v | 90 a |
| ethanol in water | |
| Control with 30% v/v ethanol in water | 0 b |
| Control with distilled water | 2 b |

a and b indicate significant differences between the different ANDEVA treatments (LSD ρ ≦ 0.05).

### b) Lethality of Oligonychus Yothersi

TABLE 3
Effect of direct application on Oligonychus yothersi adults
in the laboratory. La Cruz, Valparaíso Region, Chile, 2009.

| Treatments | Lethality (%) |
|---|---|
| Avocado seed extract at 5000 ppm in 30% (v/v) | 100 a |
| ethanol in water | |
| Control with 30% (v/v) ethanol in water | 0 b |
| Control with distilled water | 0 b |

a and b indicate significant differences between the different ANDEVA treatments (LSD ρ ≦ 0.05).

### c) Lethality of Tetranychus Cinnabarinus

TABLE 4
Effect of direct application on Tetranychus cinnabarinus adults in the
laboratory. La Cruz, Valparaíso Region, Chile, 2009.

| Treatments | Lethality (%) |
|---|---|
| Avocado seed extract at 5000 ppm in 30% (v/v) | 100 a |
| ethanol in water | |
| Control with 30% (v/v) ethanol in water | 0 b |
| Control with distilled water | 0 b |

a and b indicate significant differences between the different ANDEVA treatments (LSD ρ ≦ 0.05).

### d) Lethality of Trialeurodes Vaporariorum

TABLE 5
Effect of direct application on Trialeurodes vaporariorum nymphs in the
laboratory. La Cruz, Valparaíso Region, Chile 2009.

| Treatments | Lethality (%) |
|---|---|
| Avocado seed extract at 5000 ppm in 30% (v/v) | 100 a |
| ethanol in water | |
| Control with 30% (v/v) ethanol in water | 2 b |
| Control with distilled water | 1 b |

a and b indicate significant differences between the different ANDEVA treatments (LSD ρ ≦ 0.05).

1. An ethanolic extract of avocado seeds containing chemical compounds with the avocadofuran structure and with a composition of 2-Furfuraldehyde (1,00%), 5-Methyl undecane (1,05%), (11Z)-Pentadecenal (0,98%), (11Z)-Hexadecenal (2,35%), (3E)-Nonadecene (1,07%), 2-Tetradecylfuran (5,58%), 2-Pentadecylfuran (7,10%), 2-Hexadecylfuran (6,52%), 2-(1Z-Heptadecenyl) furan (2,85%), 2-(1E-Pentadecenyl) furan (2,15%), 2-(1E-Heptadecenyl) furan (5,60%), 2-(8Z, 11Z-Heptadecadienyl) furan (5,49%), 2-(8Z, 11E-Heptadecadienyl) furan (33,53%), 2-(1E, 8Z, 11Z-Heptadecatrienyl) furan (15,56%), and other unidentified compounds (9,17%).

2. An ethanolic extract of avocado seeds with a composition of claim 1 is to be used as a miticide and insecticide.

3. The use of an ethanolic extract of avocado seeds according to claim 2 is useful against mature individuals of species O. yothersi.

4. The use of an ethanolic extract of avocado seeds according to claim 3, wherein a concentration of 5000 ppm causes the death of mature individuals of the O. yothersi species within 24 hours.

5. The use of an ethanolic extract of avocado seeds according to claim 2 is useful against mature individuals of the T. cinnabarinus species.

6. The use of an ethanolic extract of avocado seeds according to claim 5, wherein a concentration of 5000 ppm causes the death of mature individuals of the T. cinnabarinus species within 24 hours.

7. The use of an ethanolic extract of avocado seeds according to claim 2 is useful against mature individuals of the P. citri species.

8. The use of an ethanolic extract of avocado seeds according to claim 7, wherein a concentration of 5000 ppm causes the death of mature individuals of the P. citri species within 24 hours.

9. The use of an ethanolic extract of avocado seeds according to claim 2 is useful against nymph stages of the T. vaporariorum species.

10. The use of an ethanolic extract of avocado seeds according to claim 9, wherein a concentration of 5000 ppm causes the death of individuals of the T. vaporariorum species within 96 hours.
